(19) United States
(12) Patent Application Publication
(10) Pub. No.: US 2026/0336011 A1
(43) Pub. Date: Oct. 29, 2026

(54) ENERGIZING COMPONENT, WELDING TORCH, WELDING SYSTEM, METHOD FOR DESIGNING ENERGIZING COMPONENT, AND CONTACT TIP

(71) Applicant: Kabushiki Kaisha Kobe Seiko Sho (Kobe Steel, Ltd.), Kobe-shi (JP)

(72) Inventors: Jinjiang WANG, Fujisawa-shi (JP); Akira OGAWA, Fujisawa-shi (JP); Tetsuya NAKAO, Fujisawa-shi (JP)

(73) Assignee: Kabushiki Kaisha Kobe Seiko Sho (Kobe Steel, Ltd.), Kobe-shi (JP)

(21) Appl. No.: 19/134,851

(22) PCT Filed: Nov. 16, 2023
(86) PCT No.: PCT/JP2023/041366

§ 371 Date: Jun. 2, 2025

(30) Foreign Application Priority Data
Dec. 16, 2022 (JP) 2022-201382

(51) Int. Cl. B23K 9/12; B23K 37/02

(52) U.S. Cl. CPC B23K 9/123; B23K 37/0229

(57) ABSTRACT

This energizing component is included in a welding torch and includes at least: a contact tip that supplies power to a welding wire; and a cylindrical tip body that connects a torch barrel on the base end side of the welding torch and the contact tip. The tip body has an eccentric guide having a first inner diameter, and a wire pressing part that causes the welding wire which has been inserted into the eccentric guide to be eccentric in a radial direction. In the contact tip, an axial-direction guide hole for guiding the welding wire up to an opening formed at an end is formed. The guide hole has a second inner diameter smaller than the first inner diameter.

### TECHNICAL FIELD

The present invention relates to a mechanism that can make weld wire constantly contact with electrode tip (constantly contact tip), and a welding torch with the energized supply parts. And it also relates to the welding system including the constantly contact tip and the torch above, and the method how to construct such a constantly weld power supply system.

### BACKGROUND ART

In general, A contact tip is not only used for guiding welding wire to the molten pool, but also play a function as a electric conductor between welding wire and power supply. Continue to feed welding wire, simultaneously, supply electricity to the welding wire through the contact tip fixed on torch, an arc welding can be performed continuously.

A welding wire, which always keep a peculiar winding while pulled out from welding wire drum or spool, can keep itself contact with contact tip's inside hole while passing through, to carry the weld current. Unfortunately, this an unstable mechanism, because it's affected by welding wire's elastic coefficient, peculiar wending curvature, and some others. Therefore, it can't keep welding wire contact steadily with contact tip, when contact tip hole's abrased and enlarged. And the contact pressure loses more quickly while using drum wire, whose peculiar winding curvature depended on drum's diameter, of course smaller than spool's.

The smaller press between wire and tip, the more unstable welding electrical circuit will become. It can cause to a sudden separation of electric conductors and rapid increase of resistance. Arc length become instable, and tip's melting should happen rapidly, what making you must alternate a new tip quickly. Accordingly, to extend the serviceable life of the contact tip regardless of the welding wire's elastic coefficient or the peculiar winding curvature and others, to building stable welding electrical supply circuit, it is necessary to introduce an added force to keep the welding wire contact constantly contact tip.

Meanwhile, PTL 1 discloses a configuration in which a pressing means that presses a welding wire against a tip contact surface is provided inside a contact tip and in which a pressing force of the pressing means is used to forcibly cause the welding wire to come into contact with an energization surface of the contact tip.

In addition, PTL 2 discloses a configuration in which there are provided a torch body extending in an axial direction and into which a welding wire is inserted, a power supply member extending on the leading end side of the torch body in the axial direction, and a pressing means that presses the torch body in a direction orthogonal to the axial direction and in which the pressing means moves the entirety of the torch body to thereby press the welding wire, which is fed from the torch body, against a power supply member side.

### CITATION LIST

### Patent Literature

PTL 1: Japanese Unexamined Patent Application Publication No. 10-34311
PTL 2: Japanese Unexamined Patent Application Publication No. 59-199673

### SUMMARY OF INVENTION

### Technical Problem

In the contact tip described in PTL 1, although electric power is stably supplied to the welding wire and the product lifetime is improved since the welding wire can be pressed against the contact surface of the contact tip by the pressing means with a constant contact force even when the size of an opening portion is increased to some extent by welding work, manufacturing costs are increased due to a complex structure of the contact tip, which is a consumable article with a relatively short product lifetime, and cost-performance is not sufficient.

In addition, in the welding torch described in PTL 2, although the product lifetime of the contact tip can be increased without making the configuration of the contact tip complex, there is a problem that the entirety of the apparatus becomes large and complex and will be very difficult to maintenance since the pressing means for moving the entirety of the torch body is necessary.

The present invention has been made in consideration of the above situations, and an object of the present invention is to provide an energizing component capable of extending the product lifetime of contact tip while stably supplying electric power to a welding wire with a simple and compact configuration in which a pressing means is not provided in the contact tip; a welding torch including the energizing component; a welding system including the energizing component; a method for designing the energizing component; and a contact tip.

### Solution to Problem

The above object of the present invention is achieved by the following configurations.
(1) An energizing component included in a welding torch for supplying electric power to a welding wire and performing arc welding,
the energizing component including at least a contact tip that supplies electric power to the welding wire, and a tip body that connects a torch barrel on a base end side of the welding torch and the contact tip to each other,
in which the tip body includes an eccentric guide that has a first inner diameter, and a wire pressing part that causes the welding wire inserted into the eccentric guide to be eccentric in a radial direction,
in which the contact tip has a guide hole that guides the welding wire, the guide hole being formed to extend in an axial direction from a leading-end opening part formed at a leading end to a rear-end opening part, and
in which the guide hole has a second inner diameter smaller than the first inner diameter.
(2) The energizing component according to (1),
in which, in the tip body, a base end guide having a third inner diameter is provided on a base end side of the eccentric guide, and
in which the third inner diameter is smaller than the first inner diameter and larger than the second inner diameter.
(3) The energizing component according to (1),
in which the wire pressing part includes at least a press member that comes into contact with the welding wire, and an elastic member for pressing the press member against the welding wire,
in which the press member is a ball-shaped member, and
in which the elastic member is a plate-spring-shaped member.
(4) The energizing component according to (3),
in which, in the wire pressing part,
the ball-shaped member is accommodated in a through hole formed in a circumferential surface of the tip body and extending in a radial direction, and
the plate-spring-shaped member clamps a circumferential surface of the tip body so as to press the ball-shaped member protruding from the through hole.
(5) The energizing component according to (2),
in which the base end guide has the third inner diameter due to an inner diameter of a conduit tube internally fitted to a rear portion side of the tip body.
(6) The energizing component according to any one of (1) to (5),
in which the wire pressing part is provided with an adjusting mechanism that enables a positional adjustment in a longitudinal direction or a circumferential direction of the tip body.
(7) A welding torch including the energizing component according to any one of (1) to (5).
(8) A welding system including:
a welding robot that includes the welding torch according to (7); and
a welding power source.
(9) A method for designing the energizing component according to (2), the method including:
a contact-force calculating step in which a contact force between a portion near a position of a leading end of the contact tip and the welding wire is calculated based on energizing-component design items constituted by at least
a first bending section between a position of a leading end of the base end guide and a position at which the wire pressing part presses the welding wire,
a second bending section between a position at which the wire pressing part presses the welding wire and a rear-end opening part of the guide hole,
a leading-end guide length that is a length of the guide hole in an axial direction,
the first inner diameter,
the second inner diameter,
the third inner diameter, and
welding wire information relating to the welding wire that is to be used for welding; and
a designing step in which a value of each of the energizing-component design items is determined such that a contact force calculated in the contact-force calculating step becomes a design contact force that is optionally determined in advance. (10) The method for designing the energizing component according (9),
in which the welding wire information includes at least one of a wire diameter of the welding wire and mechanical performance of the welding wire.
(11) A contact tip that is to be used in a welding torch for supplying electric power to a welding wire and performing arc welding,
in which the contact tip has an inner surface that has
a coupling portion having a cylindrical shape and disposed at a rear end to be connected to a leading end of a tip body in an axial direction,
a tapered portion having a diameter that decreases from the coupling portion toward a front side in an axial direction, and
a guide hole that guides the welding wire, the guide hole being formed to extend in an axial direction from a rear-end opening part in communication with a leading end of the tapered portion to a leading-end opening part formed at a leading end of the contact tip,
in which a second inner diameter forming the guide hole is larger than a wire shape of the welding wire and smaller than a first inner diameter of a pressing space in which the welding wire is pressed in a radial direction by an eccentric guide of the tip body, and
in which the guide hole comes into contact at the rear-end opening part and the leading-end opening part with the welding wire.

### Advantageous Effects of Invention

According to the present invention, with the wire pressing part, which makes power supply to the welding wire stable by utilizing a reaction force of the bending rigidity of the welding wire, being arranged at the tip body, it is possible to configure the entirety of the welding torch to be compact and simplify the configuration of the contact tip, which needs frequent replacement, and thus is possible to suppress costs to be low.

### BRIEF DESCRIPTION OF DRAWINGS

FIG. 1 is a schematic side view of a welding robot in which one embodiment of a welding torch according to the present invention is used.

FIG. 2 is a side view illustrating a welding torch according to an embodiment.

FIG. 3 is a perspective view illustrating an energizing component.

FIG. 4 is an exploded perspective view illustrating an energizing component.

FIG. 5 is a central cross-sectional view illustrating an energizing component.

FIG. 6 is a sectional view illustrating a wire pressing part.

FIG. 7 is a central cross-sectional view illustrating an energizing component according to a second embodiment.

### DESCRIPTION OF EMBODIMENTS

Hereinafter, a configuration of a welding torch including an energizing component according to the present invention will be described with reference to the accompanying drawings. Note that each of the drawings is created for description of the present invention and the embodiments of the present invention are not limited to the contents illustrated in the drawings.

First, to grasp an overall image of the welding torch according to the present embodiment, a welding system 1 in which the welding torch is used will be described.

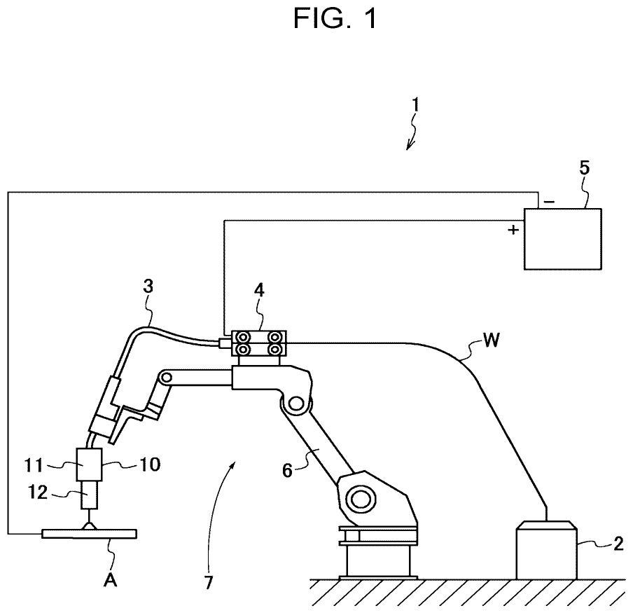

As illustrated in FIG. 1, the welding system 1 includes a wire pack 2, a welding power source 5, and a welding robot 7. The welding robot 7 includes a torch cable 3, a wire supplying device 4, a manipulator 6, and a welding torch 10. Note that the sign A in FIG. 1 indicates a base material, which is a welding target.

As illustrated in FIG. 1, the wire pack 2 is a supplying source of a welding wire W and stores a predetermined amount of the welding wire W in a pack winding form. As the welding wire W, for example, a copper-plated wire, a non-copper-plated wire, or the like is usable. In addition, the welding wire W has a peculiar winding by being stored to be curved in the wire pack 2.

Welding current supplied from the welding power source 5, the welding wire W stored in the wire pack 2, and a shield gas supplied from a shield-gas storage device, which is not illustrated, are supplied to the welding torch 10 through the torch cable 3. The torch cable 3 has one end connected to the wire supplying device 4 and another end connected to the welding torch 10.

The wire supplying device 4 feeds the welding wire W by a roller or the like through the torch cable 3 to supply the welding wire W to the welding torch 10. With this wire supplying device 4, the welding wire W is automatically supplied to the welding torch 10.

The welding power source 5 is a supplying source of welding current and supplies the welding current to the welding torch 10 through the wire supplying device 4 and the torch cable 3.

The manipulator 6 is an articulated robot having a leading end to which the welding torch 10 is attached, and an operation of the manipulator 6 is controlled by a robot control device, which is not illustrated.

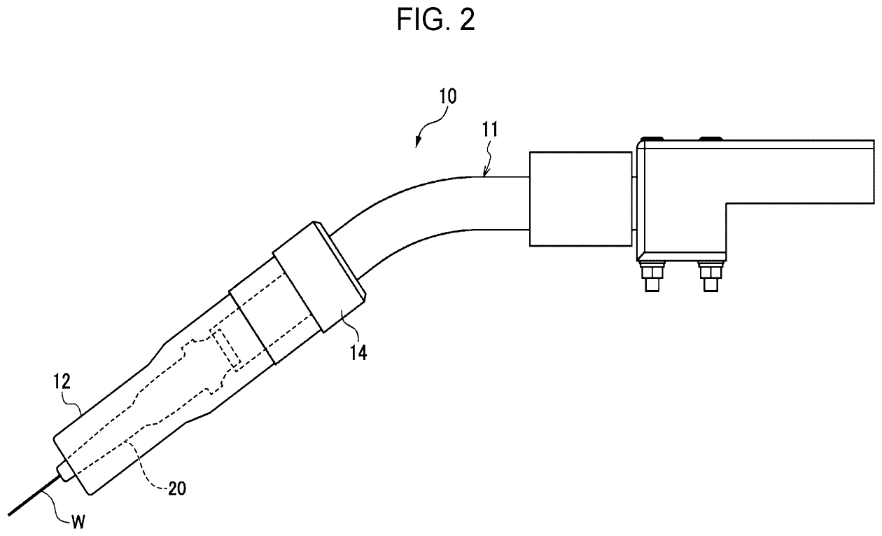

FIG. 2 is a side view illustrating the welding torch according to the embodiment. The welding torch 10 includes a torch barrel 11, a nozzle 12, and an energizing component 20 and performs gas shielded arc welding.

The torch barrel 11 is a metallic cylindrical member, and the energizing component 20 and the nozzle 12 are detachably attached to the leading end side of the torch barrel 11. An internal thread portion, which is not illustrated, to which the energizing component 20 is to be attached and a cap nut 14 to which the nozzle 12 is to be attached are provided on the leading end side of the torch barrel 11.

In addition, the torch barrel 11 includes a conduit tube 13 that guides the welding wire W. The conduit tube 13 is provided to protrude from the leading end of the torch barrel 11, and a protruding portion is inserted into a tip body 30 that constitutes the energizing component 20.

In addition, the welding wire W, the welding current supplied from the welding power source 5, and the shield gas supplied from the shield-gas storage device, which is not illustrated, are supplied through the torch barrel 11 toward the energizing component 20.

The nozzle 12 is a cylindrical member whose front and rear ends are open, and the energizing component 20, which is provided on the leading end side of the torch barrel 11, and an orifice, which is not illustrated, externally fitted to the energizing component 20 are accommodated in the nozzle 12. A shield gas ejected from a circumferential surface of the energizing component 20 and rectified by the orifice is supplied through an open portion at the leading end of the nozzle 12.

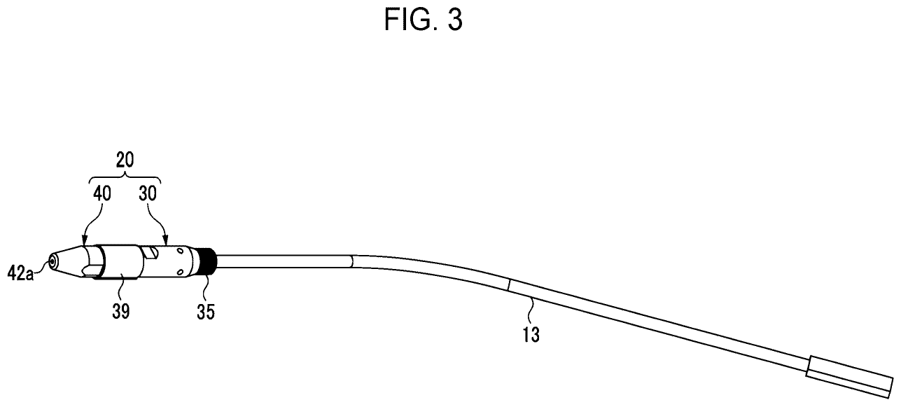

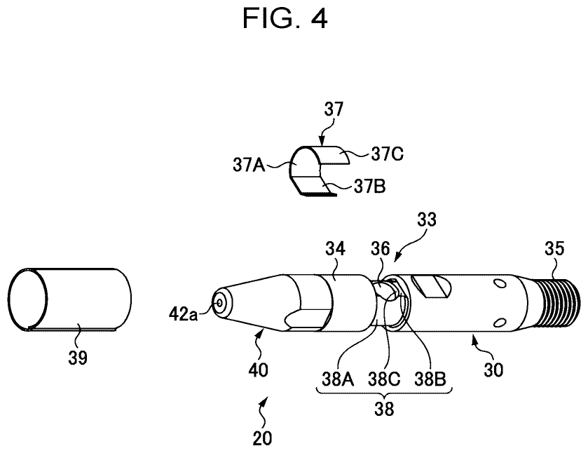

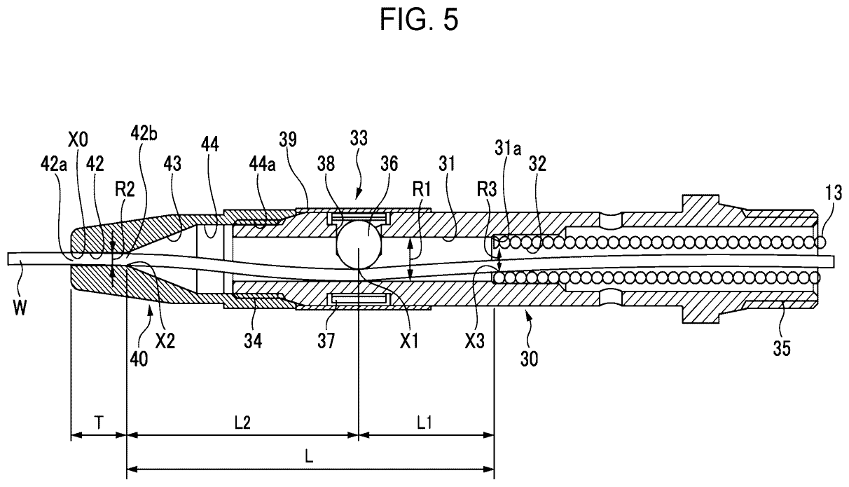

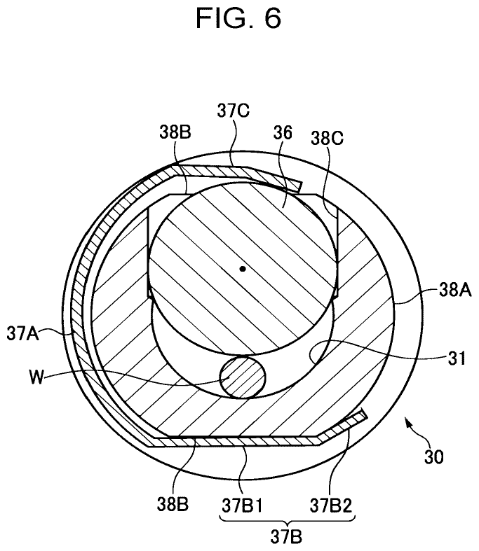

Next, on the basis of FIG. 3 to FIG. 6, a configuration of the energizing component will be described. FIG. 3 is a perspective view illustrating the energizing component, FIG. 4 is an exploded perspective view illustrating the energizing component, FIG. 5 is a central cross-sectional view illustrating the energizing component, and FIG. 6 is a sectional view illustrating a wire pressing part.

The energizing component 20 includes the tip body 30 attached to the leading end side of the torch barrel 11, and a contact tip 40 attached to the leading end of the tip body 30.

The tip body 30 is a cylindrical member extending in an axial direction and guides the welding wire W supplied from the torch barrel 11 side, which is the rear side, toward the contact tip 40 on the front side. The tip body 30 is made of an electrically conductive metal material, such as copper.

The tip body 30 includes a wire pressing part 33 that causes the inserted welding wire W to be eccentric; an eccentric guide 31 that forms a cylindrical space (hereinafter referred to as a pressing space) in which the welding wire W is caused to be eccentric; and a base end guide 32 that forms a cylindrical space positioned on the rear side of the eccentric guide 31. FIG. 5 can be referred for this configuration.

At the outer circumferential surface of the tip body 30, an external thread portion 34 to which the contact tip 40 is to be attached is formed on the front end side, and an external thread portion 35 that is to be attached to the leading end side of the torch barrel 11 is formed on the rear end side.

The pressing space formed by the eccentric guide 31 is present at the inner circumferential surface of the tip body 30. The eccentric guide 31 is disposed at a front half portion of the tip body 30 and includes the wire pressing part 33 provided at an intermediate portion in the axial direction. The pressing space inside the eccentric guide 31 has a previously designed first inner diameter R1.

The wire pressing part 33 includes a ball-shaped press member 36 that presses the welding wire W inserted into the eccentric guide 31; an urging member 37 that urges the press member 36 toward the outer side in a radial direction; a holding portion 38 that is provided at the tip body 30 to hold the press member 36 and the urging member 37; and a cover body 39 that covers the press member 36 and the urging member 37 along the outer circumferential surface of the tip body 30. FIG. 4 and FIG. 5 can be referred for this configuration.

As illustrated in FIG. 4 to FIG. 6, the holding portion 38 has a groove portion 38A that is formed by recessing the outer surface of the eccentric guide 31 over the entirety of the outer surface in the circumferential direction; a pair of notched surfaces 38B that are formed at 180° symmetrical positions with respect to a cylindrical bottom surface of the groove portion 38A; and a through hole 38C that extends between one of the notched surfaces 38B and the pressing space in the radial direction. The diameter of the through hole 38C is slightly larger than the width direction of the notched surface 38B. FIG. 4 can be referred for this configuration.

The press member 36 is a steel ball that is fitted and accommodated in the through hole 38C and is held to be movable along the through hole 38C in the radial direction. The diameter of the press member 36 is larger than the first inner diameter R1 of the eccentric guide 31 and smaller than the outer diameter of the eccentric guide 31. Therefore, it is possible to prevent the steel ball, which is the press member 36, from entering the eccentric guide 31.

The urging member 37 is a plate spring that is formed in a C-shape along the groove portion 38A and includes a pair of clamping parts 37B and 37C that hold the pair of notched surfaces 38B between the clamping parts 37B and 37C, and a coupling portion 37A that extends in an arc shape along the groove portion 38A and couples the pair of clamping parts 37B and 37C to each other. For example, the C-shaped plate spring is a rod clamp. The clamping part 37C on one side is formed to be bent inward to press the ball-shaped press member 36 in a direction in which the press member 36 is inserted into the through hole 38C. The clamping part 37B on the other side has an abutment surface 37B1 that abuts against the entirety of the notched surface 38B in the width direction, and a locking part 37B2 that is an end portion of the clamping part 37B formed to be bent with respect to the abutment surface 37B1 so as to extend along the groove portion 38A. FIG. 6 can be referred for this configuration.

The cover body 39 is a cylindrical member formed to be longer than the groove portion 38A in the axial direction and mounted so as to cover the groove portion 38A. With the cover body 39 covering the outer circumferential side of the groove portion 38A at which the press member 36 and the urging member 37 are set, it is possible to reliably prevent the press member 36 from coming off from the through hole 38C during welding work.

The cover body 39 is formed by a sheet spring member and formed to have an inner diameter that is smaller before being elastically deformed than the outer diameter of the tip body 30. Consequently, it is possible by elastically deforming the cover body 39 in a radially expanding direction to easily attach the cover body 39 to a predetermined position for covering the groove portion 38A. In addition, since the cover body 39 can be formed with a thin member, it is possible to form the tip body 30 to be compact in the radial direction.

The base end guide 32 is disposed at a rear half portion of the tip body 30, and the inner circumferential surface of the base end guide 32 is constituted by a leading portion of the conduit tube 13 internally fitted to the torch barrel 11. Specifically describing, the leading end of the conduit tube 13 extending from the torch barrel 11 is accommodated inside the base end guide 32 of the tip body 30 so as to abut against a step 31a provided at the rear end of the pressing space. The inner diameter of the conduit tube 13 defines a third inner diameter of the base end guide 32. As illustrated in FIG. 5, the third inner diameter R3 is smaller than the first inner diameter R1.

The contact tip 40 is a cylindrical member extending in the axial direction, and a front half portion of the contact tip 40 is formed in a truncated cone shape with a diameter decreasing toward the leading end. A leading-end opening part 42a through which the welding wire W is fed is formed at the leading end of the contact tip 40. The contact tip 40 is made of an electrically conductive metal material, such as copper, and the contact tip 40 supplies welding current to the welding wire W.

The inner surface of the contact tip 40 has a cylindrical coupling portion 44 at which an internal thread portion 44a that is arranged at the rear end to be fastened to the external thread portion 34 at the leading end of the tip body 30 in the axial direction is formed; a tapered portion 43 that has a diameter that decreases from the front end of the coupling portion 44 toward the front side in the axial direction; and a guide hole 42 that is formed to extend in the axial direction from a rear-end opening part 42b in communication with the leading end of the tapered portion 43 to the leading-end opening part 42a and that guides the welding wire W.

The guide hole 42 is formed along the center axis of the energizing component 20 and has a leading-end guide length T, which is a length from the leading-end opening part 42a to the rear-end opening part 42b in the axial direction, and a second inner diameter R2. The second inner diameter R2 is smaller than each of the first inner diameter R1 and the third inner diameter R3 and larger than a wire diameter of the welding wire W.

The leading-end guide length T and the second inner diameter R2 are set to enable the welding wire W, which has been caused to be eccentric with respect to the center axis of the energizing component 20 by the wire pressing part 33, to come into contact with the rear-end opening part 42b and the leading-end opening part 42a that are present at the front end and the rear end of the guide hole 42, respectively. FIG. 5 can be referred for this configuration. Specifically, the second inner diameter is desirably 1.05 to 1.35 times the wire diameter of the welding wire W.

In the coupling portion 44, the internal thread portion 44a to be coupled to the leading end side of the tip body 30 is formed on the rear end side. Consequently, the coupling portion 44 is formed in a cylindrical shape that has, from the rear end side to the front end side in communication with the tapered portion 43, an inner diameter that is substantially the same as the first inner diameter R1 or that is larger than the first inner diameter R1.

The tapered portion 43 is formed to have a diameter that gradually decreases from the rear end toward the front end, and, in the illustrated example, the rear end of the tapered portion 43 is in communication with the front end side of the coupling portion 44 having a diameter larger than the first inner diameter R1, and the front end of the tapered portion 43 is in communication with the rear-end opening part 42b of the guide hole 42 having the second inner diameter R2.

The tapered portion 43 and the coupling portion 44 are not limited to have the aforementioned shapes as long as it is configured such that the welding wire W bent by the wire pressing part 33 does not come into contact with the energizing component 20 side between a position at which the press member 36 presses the welding wire W to the rear-end opening part 42b of the guide hole 42.

According to the configuration described above, the first inner diameter R1, the second inner diameter R2, and the third inner diameter R3 of the energizing component 20 are arranged coaxially, the second inner diameter R2 is the smallest, and the first inner diameter R1 is the largest. In addition, each of the leading-end opening part 42a and the rear-end opening part 42b has a size that is substantially the same as the second inner diameter R2.

Hereinafter, operations and effects of the energizing component 20 will be described.

By being caused to be eccentric by the wire pressing part 33, the welding wire W supplied from the torch barrel 11 to the energizing component 20 comes into contact with the energizing component 20 side at a third contact position X3 present at the position of the leading end of the base end guide 32 (conduit tube 13) having the third inner diameter R3, a first contact position X1 at which the welding wire W is pressed inside the eccentric guide 31 having the first inner diameter R1 by the press member 36, a second contact position X2 near the rear-end opening part 42b of the guide hole 42, and a leading-end contact position X0 near the leading-end opening part 42a of the guide hole 42.

Therefore, as illustrated in FIG. 5, the welding wire W guided inside the welding torch 10 to the tip body 30 side is pressed by the wire pressing part 33 such that the welding wire W is caused to be eccentric largely toward the outer side in the radial direction in a first bending section L1 and such that the bent amount of the welding wire W decreases in the second bending section L2. In addition, in a section in which the guide hole 42 has the leading-end guide length T, the welding wire W is guided so as to come into contact with both the second contact position X2 and the leading-end contact position X0. Here, in the axial direction of the energizing component 20, the first bending section L1 is between the third contact position X3 and the first contact position X1, and the second bending section L2 is between the first contact position X1 and the second contact position X2.

According to the above configuration, it is possible, regardless of the presence/absence of a peculiar winding of the welding wire W, to forcibly cause the welding wire W to come into contact with a portion near the position of the leading end of the contact tip 40 with a predetermined contact force. In other words, it is possible to forcibly supply electric power to the welding wire W. Consequently, it is possible, even when the leading-end opening part 2a of the contact tip 40 is widened by welding work, to maintain power supply to the welding wire W and thus possible to extend the lifetime of the contact tip 40.

Note that the inner diameters of the inner circumference of the energizing component 20 in the present embodiment have the relationship in which the first inner diameter R1>the third inner diameter R3>the second inner diameter R2 but may be configured to have only a relationship in which the first inner diameter R1 >the second inner diameter R2. In this case, the third inner diameter R3, which is the inner diameter of the conduit tube 13, has the same dimension as the first inner diameter R1 of the pressing space.

In addition, with the wire pressing part 33, which causes the welding wire W to be eccentric, being arranged on the tip body 30 side, the contact tip 40, which needs more frequent replacement than the tip body 30, can have a simple configuration. Therefore, it is possible to suppress manufacturing costs and maintenance costs of the entirety of the energizing component 20.

In addition, with the ball-shaped press member 36 being employed as the wire pressing part 33, the wire pressing part 33 rotates while being in point-contact with the welding wire W supplied by the press member 36, which causes the welding wire W to be eccentric, and therefore, it is possible to reduce a frictional force in the supplying direction and thus possible to prevent supplying resistance of the welding wire W from increasing unnecessarily.

Next, a method for designing the energizing component 20 will be described. The method for designing the energizing component 20 including the wire pressing part 33 includes a contact-force calculating step and a designing step.

In the contact-force calculating step, a contact force with which the welding wire W comes into contact with a portion near the leading end of the contact tip 40, specifically, the second contact position X2 is calculated on the basis of information relating to various design items. As the design items, at least the first bending section L1, the second bending section L2, the leading-end guide length T, the first inner diameter R1, the second inner diameter R2, the third inner diameter R3, and information relating to the welding wire W are used.

The information relating to the welding wire W includes at least one of the wire diameter of the welding wire W, information relating to the mechanical performance of the welding wire W, and information relating to the peculiar winding of the welding wire W. As the information relating to the mechanical performance of the welding wire W, Young's modulus or Poisson's ratio, which is information relating to rigidity or the like, are used.

As a design item other than the aforementioned design items, the pressing force with which the wire pressing part 33 presses the welding wire W or the amount of eccentricity of the welding wire W caused by the wire pressing part 33 may be added.

The contact force with which the welding wire W comes into contact with a portion near the leading end of the contact tip 40 becomes stronger as the first bending section L1 or the second bending section L2 becomes short, becomes stronger as a difference between the first inner diameter R1 and the third inner diameter R3 or a difference between the first inner diameter R1 and the second inner diameter R2 increases, and becomes stronger as the rigidity of the welding wire W becomes higher.

In the designing step, a value of each of the design items when a contact force calculated in the contact-force calculating step is a contact force that is optionally determined in advance is determined. Note that the design items are preferably designed such that a design contact force with which the welding wire W comes into contact with the second contact position X2 on the contact tip 40 side is in the range of 1 N to 15 N.

According to the aforementioned designing method, the energizing component 20 in which the welding wire W comes into contact with a portion near the position of the leading end of the contact tip 40 with a suitable contact force can be designed for each of the welding wires W of different types and each of the welding wires W having different bending tendencies due to accommodation methods.

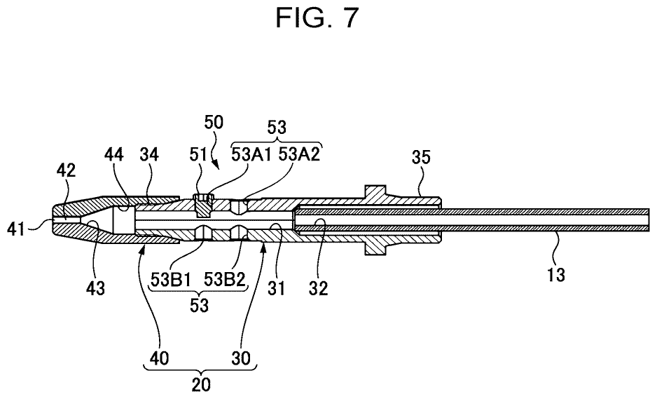

Next, a second embodiment of the wire pressing part will be described on the basis of FIG. 7. FIG. 7 is a central cross-sectional view illustrating an energizing component according to the second embodiment. A wire pressing part 50 includes a pressing bolt 51 that is to be used as a press member; a through hole 53 that is a screw hole extending from the circumferential surface of the eccentric guide 31 to the pressing space in the radial direction; and adjusting mechanisms 53A1, 53A2, 53B1, and 53B2 that enable a pressing position at which the pressing bolt 51 presses the welding wire W to be adjusted in the axial direction and the circumferential direction.

By being fastened to the through hole 53, the pressing bolt 51 can press the welding wire W, which is inserted into the eccentric guide 31, toward the outer side in the radial direction. By adjusting the amount of fastening of the pressing bolt 51 to the through hole 53, it is possible to steplessly adjust the length of protrusion of a shaft portion of the pressing bolt 51 in the eccentric guide 31.

As illustrated in FIG. 7, the adjusting mechanisms 53A1, 53A2, 53B1, and 53B2 are constituted by a plurality of the through holes 53 that are aligned next to each other in the axial direction and the circumferential direction of the eccentric guide 31. Specifically, the adjusting mechanisms 53A1, 53A2, 53B1, and 53B2 are constituted by a first front through hole 53A1 and a first rear through hole 53A2 that are aligned next to each other in the axial direction of the eccentric guide 31; a second front through hole 53B1 that is aligned next to the first front through hole 53A1 in the circumferential direction of the eccentric guide 31; and a second rear through hole 53B2 that is aligned next to the first rear through hole 53A2 in the circumferential direction of the eccentric guide 31.

With the aforementioned wire pressing part 50, it is possible by adjusting the amount of fastening performed by the pressing bolt 51 to finely adjust the amount of the displacement of the welding wire W. Consequently, for example, when the contact force with which the welding wire W comes into contact with the contact tip 40 is weakened as a result of the leading-end opening part 42a being widened by welding work, it is possible to return the contact force with which the welding wire W comes into contact with the contact tip 40 to an appropriate value again by increasing the amount of fastening performed by the pressing bolt 51. Therefore, it is possible to further extend the lifetime of the contact tip.

With the aforementioned adjusting mechanisms 53A1, 53A2, 53B1, and 53B2, it is possible by fastening the pressing bolt 51 to the through holes 53, which are different in the axial direction, to adjust the position in the axial direction at which the welding wire W is caused to be eccentric. In other words, versatility is improved since the position of the first contact position X1 can be easily changed in the longitudinal direction of the energizing component 20 without any change in the configuration of the energizing component 20.

In addition, with the adjusting mechanisms 53A1, 53A2, 53B1, and 53B2, it is possible, without changing the position of the first contact position X1 in the axial direction, by fastening the pressing bolt 51 to the through holes 53, which are different in the circumferential direction, to change the direction to which the welding wire W is caused to be eccentric in the radial direction. In other words, versatility is improved since the direction toward which the welding wire W is pressed can be changed in the circumferential direction of the eccentric guide 31 in accordance with the peculiar winding of the welding wire W.

Note that the adjusting mechanisms 53A1, 53A2, 53B1, and 53B2 are not limited to be in the configuration in which a plurality of the through holes 53 are aligned next to each other in the axial direction and the circumferential direction as long as it is configured such that the position of the press member 36 (pressing bolt 51), which causes the welding wire W to be eccentric, is adjustable in the axial direction or/and the circumferential direction of the tip body 30. For example, the adjusting mechanisms may be each configured to support the press member, which is attached to the tip body 30, so as to be able to slide and move in the axial direction and the circumferential direction.

Note that the present invention is not limited to the aforementioned embodiments, and combination of the configurations of the embodiments to each other and changes/application by a person skilled in the art on the basis of the matters described in the present description and known technologies are also intended by the present invention and are included in the scope that should be protected.

As described above, the present description discloses the following matters.
(1) An energizing component included in a welding torch for supplying electric power to a welding wire and performing arc welding,
the energizing component including at least a contact tip that supplies electric power to the welding wire, and a tip body that connects a torch barrel on a base end side of the welding torch and the contact tip to each other,
in which the tip body includes an eccentric guide that has a first inner diameter, and a wire pressing part that causes the welding wire inserted into the eccentric guide to be eccentric in a radial direction,
in which the contact tip has a guide hole that guides the welding wire, the guide hole being formed to extend in an axial direction from a leading-end opening part formed at a leading end to a rear-end opening part, and
in which the guide hole has a second inner diameter smaller than the first inner diameter.
   According to the present configuration, with the wire pressing part, which causes the welding wire to come into contact with the contact tip stably by utilizing the reaction force of the bending rigidity of the welding wire, being arranged at the tip body, it is possible to configure the entirety of the welding torch to be compact and simplify the configuration of the contact tip, which needs relatively frequent replacement, and thus is possible to suppress costs to be low.
(2) The energizing component according to (1),
in which, in the tip body, a base end guide having a third inner diameter is provided on a base end side of the eccentric guide, and
in which the third inner diameter is smaller than the first inner diameter and larger than the second inner diameter.
   According to the present configuration, since it is possible to deform the welding wire, which is caused to be eccentric by the wire pressing part, into a mountain shape, the force with which the welding wire comes into contact with the contact tip side is made more stable, and designing of the energizing component becomes easier.
(3) The energizing component according to (1) or (2),
in which the wire pressing part includes at least a press member that comes into contact with the welding wire, and an elastic member for pressing the press member against the welding wire,
in which the press member is a ball-shaped member, and
in which the elastic member is a plate-spring-shaped member.
   According to the present configuration, since the pressing member pressed against the welding wire is formed in a ball shape, the wire pressing part can cause the welding wire to be eccentric in the radial direction and can also prevent the force required for feeding the welding wire through the opening portion of the contact tip from unnecessarily increasing.
(4) The energizing component according to (3),
in which, in the wire pressing part,
the ball-shaped member is accommodated in a through hole formed in a circumferential surface of the tip body and extending in a radial direction, and
the plate-spring-shaped member clamps a circumferential surface of the tip body so as to press the ball-shaped member protruding from the through hole.
   According to the present configuration, since it is possible to simplify the configuration of the wire pressing part, it is possible to suppress costs to be low, and, since assembly work of components that constitute the wire pressing part is also simplified, the ease of maintenance is also increased.
(5) The energizing component according to any one of (2) to (4),
in which the base end guide has the third inner diameter due to an inner diameter of a conduit tube internally fitted to a rear portion side of the tip body.
   According to the present configuration, it is possible by changing the conduit tube or adjusting the length of the conduit tube to easily set/change the size of the third inner diameter and the position of the leading end of the base end guide having the third inner diameter.
(6) The energizing component according to any one of (1) to (5),
in which the wire pressing part is provided with an adjusting mechanism that enables a positional adjustment in a longitudinal direction or a circumferential direction of the tip body.
   According to the present configuration, versatility is improved since the position of pressing the welding wire can be changed/adjusted without any changes in the tip body and the contact tip.
(7) A welding torch including the energizing component according to any one of (1) to (6).
   According to the present configuration, the welding torch that can make power supply to the welding wire stable by causing the welding wire to come into contact with the contact tip by utilizing the reaction force of the bending rigidity of the welding wire can be configured to be compact with reduced costs.
(8) A welding system including:
a welding robot that includes the welding torch according to (7) ; and
a welding power source.
   According to the present configuration, the welding system, which includes the welding torch that can make power supply to the welding wire stable by causing the welding wire to come into contact with the contact tip by utilizing the reaction force of the bending rigidity of the welding wire, can be configured with reduced costs.
(9) A method for designing the energizing component according to (2), the method including:
a contact-force calculating step in which a contact force between a portion near a position of a leading end of the contact tip and the welding wire is calculated based on energizing-component design items constituted by at least
a first bending section between a position of a leading end of the base end guide and a position at which the wire pressing part presses the welding wire,
a second bending section between a position at which the wire pressing part presses the welding wire and a rear-end opening part of the guide hole,
a leading-end guide length that is a length of the guide hole in an axial direction,
the first inner diameter,
the second inner diameter,
the third inner diameter, and
welding wire information relating to the welding wire that is to be used for welding; and
a designing step in which a value of each of the energizing-component design items is determined such that a contact force calculated in the contact-force calculating step becomes a design contact force that is optionally determined in advance.
   According to the present configuration, it is possible to smoothly and easily design the energizing component in which the contact tip and the welding wire are forcibly caused to come into contact with each other with a suitable contact force.
(10) The method for designing the energizing component according (9),
in which the welding wire information includes at least one of a wire diameter of the welding wire and mechanical performance of the welding wire.
   According to the present configuration, it is possible, even when the wire shape and the mechanical characteristics of the welding wire supplied by the welding torch are different, to smoothly and easily design the energizing component in which the contact tip and the welding wire are forcibly caused to come into contact with each other with a suitable contact force.
(11) A contact tip that is to be used in a welding torch for supplying electric power to a welding wire and performing arc welding,
in which the contact tip has an inner surface that has
a coupling portion having a cylindrical shape and disposed at a rear end to be connected to a leading end of a tip body in an axial direction,
a tapered portion having a diameter that decreases from the coupling portion toward a front side in an axial direction, and
a guide hole that guides the welding wire, the guide hole being formed to extend in an axial direction from a rear-end opening part in communication with a leading end of the tapered portion to a leading-end opening part formed at a leading end of the contact tip,
in which a second inner diameter forming the guide hole is larger than a wire shape of the welding wire and smaller than a first inner diameter of a pressing space in which the welding wire is pressed in a radial direction by an eccentric guide of the tip body, and
in which the guide hole comes into contact at the rear-end opening part and the leading-end opening part with the welding wire.
   According to the present configuration, it is possible to obtain the contact tip with which the welding wire comes into contact with a suitable contact force.

Although various embodiments have been described above with reference to the drawings, there is no need to say that the present invention is not limited to such examples. It is obvious that various modification examples or correction examples can be conceived by a person skilled in the art in the scope described in the claims, and it should be naturally understood that these examples also belong to the technical scope of the present invention. In addition, constituent components in the aforementioned embodiments may be optionally combined together within a scope not departing from the gist of the invention.

Note that the present application is based on Japanese Patent Application (No. 2022-201382) filed on Dec. 16, 2022, the contents of which are incorporated herein by reference.

### REFERENCE SIGNS LIST

1 welding system
2 wire pack
3 torch cable
4 wire supplying device
5 welding power source
6 manipulator
7 welding robot
10 welding torch
11 torch barrel
12 nozzle
13 conduit tube
14 cap nut
20 energizing component
30 tip body
31 eccentric guide
31a step
32 base end guide
33 wire pressing part
34, 35 external thread portion
36 press member, steel ball (ball-shaped member)
37 urging member, plate spring (elastic member)
38 holding portion
38A groove portion
38B notched surface
38B1 abutment surface
38B2 locking part
38C through hole
39 cover body
40 contact tip
42 guide hole
42a leading-end opening part
42b rear-end opening part
43 tapered portion
44 coupling portion
44a internal thread portion
50 wire pressing part
51 pressing bolt
53 through hole
53A1 first front through hole (adjusting mechanism)
53A2 first rear through hole (adjusting mechanism)
53B1 second front through hole (adjusting mechanism)
53B2 second rear through hole (adjusting mechanism)
W welding wire
R1 first inner diameter
R2 second inner diameter
R3 third inner diameter
L1 first bending section
L2 second bending section
X0 leading-end contact position
X1 first contact position
X2 second contact position
X3 third contact position
T leading-end guide length

1. An energizing component included in a welding torch for supplying electric power to a welding wire and performing arc welding,
the energizing component comprising at least a contact tip that supplies electric power to the welding wire, and a tip body that connects a torch barrel on a base end side of the welding torch and the contact tip to each other,
wherein the tip body includes an eccentric guide that has a first inner diameter, and a wire pressing part that causes the welding wire inserted into the eccentric guide to be eccentric in a radial direction,
wherein the contact tip has a guide hole that guides the welding wire, the guide hole being formed to extend in an axial direction from a leading-end opening part formed at a leading end to a rear-end opening part, and
wherein the guide hole has a second inner diameter smaller than the first inner diameter.

2. The energizing component according to claim 1,
wherein, in the tip body, a base end guide having a third inner diameter is provided on a base end side of the eccentric guide, and
wherein the third inner diameter is smaller than the first inner diameter and larger than the second inner diameter.

3. The energizing component according to claim 1,
wherein the wire pressing part includes at least a press member that comes into contact with the welding wire, and an elastic member for pressing the press member against the welding wire,
wherein the press member is a ball-shaped member, and
wherein the elastic member is a plate-spring-shaped member.

4. The energizing component according to claim 3,
wherein, in the wire pressing part,
the ball-shaped member is accommodated in a through hole formed in a circumferential surface of the tip body and extending in a radial direction, and
the plate-spring-shaped member clamps a circumferential surface of the tip body so as to press the ball-shaped member protruding from the through hole.

5. The energizing component according to claim 2,
wherein the base end guide has the third inner diameter due to an inner diameter of a conduit tube internally fitted to a rear portion side of the tip body.

6. The energizing component according to claim 1,
wherein the wire pressing part is provided with an adjusting mechanism that enables a positional adjustment in a longitudinal direction or a circumferential direction of the tip body.

7. A welding torch comprising the energizing component according to claim 1.

8. A welding system comprising:
a welding robot that includes the welding torch according to claim 7; and
a welding power source.

9. A method for designing the energizing component according to claim 2, the method comprising:
a contact-force calculating step in which a contact force between a portion near a position of a leading end of the contact tip and the welding wire is calculated based on energizing-component design items constituted by at least
a first bending section between a position of a leading end of the base end guide and a position at which the wire pressing part presses the welding wire,
a second bending section between a position at which the wire pressing part presses the welding wire and a rear-end opening part of the guide hole,
a leading-end guide length that is a length of the guide hole in an axial direction,
the first inner diameter,
the second inner diameter,
the third inner diameter, and
welding wire information relating to the welding wire that is to be used for welding; and
a designing step in which a value of each of the energizing-component design items is determined such that a contact force calculated in the contact-force calculating step becomes a design contact force that is optionally determined in advance.

10. The method for designing the energizing component according to claim 9,
wherein the welding wire information includes at least one of a wire diameter of the welding wire and mechanical performance of the welding wire.

11. A contact tip that is to be used in a welding torch for supplying electric power to a welding wire and performing arc welding,
wherein the contact tip has an inner surface that has
a coupling portion having a cylindrical shape and disposed at a rear end to be connected to a leading end of a tip body in an axial direction,
a tapered portion having a diameter that decreases from the coupling portion toward a front side in an axial direction, and
a guide hole that guides the welding wire, the guide hole being formed to extend in an axial direction from a rear-end opening part in communication with a leading end of the tapered portion to a leading-end opening part formed at a leading end of the contact tip,
wherein a second inner diameter forming the guide hole is larger than a wire shape of the welding wire and smaller than a first inner diameter of a pressing space in which the welding wire is pressed in a radial direction by an eccentric guide of the tip body, and
wherein the guide hole comes into contact at the rear-end opening part and the leading-end opening part with the welding wire.
